(19) United States
(12) Patent Application Publication
(10) Pub. No.: US 2024/0127173 A1
(43) Pub. Date: Apr. 18, 2024

(54) USING CAPTURED RECIPES TO GENERATE TAILORED HAIRCUT TREATMENTS

(71) Applicant: Quis T. BAKIR, Fairfax Station, VA (US)

(72) Inventor: Quis T. BAKIR, Fairfax Station, VA (US)

(21) Appl. No.: 18/363,347

(22) Filed: Aug. 1, 2023

Related U.S. Application Data
(63) Continuation-in-part of application No. 17/322,835, filed on May 17, 2021.
Application No. 17/322,835 is a continuation of application No. 15/601,726, filed on May 22, 2017, now Pat. No. 11,010,708.
(60) Provisional application No. 62/339,092, filed on May 20, 2016.

(51) Int. Cl. G06Q 10/087; G06Q 10/067; G06Q 30/0601

(52) U.S. Cl. CPC G06Q 10/087; G06Q 10/067; G06Q 30/0635; G06Q 30/0641

(57) ABSTRACT

The technologies described herein are generally directed to using captured treatment recipes to generate tailored haircare mixtures for use by stylists for clients of a hair salon. For example, a method described herein can include, based on an identified service request to perform a service for a client and a measurement by the automatic powdered ingredient dispenser, dispense, a selected amount of a powdered ingredient. The method can further include, based on the selected amount of the powdered ingredient, dispense a selected amount of a liquid ingredient. Further, the method can include, facilitating combining the selected amount of the powdered ingredient and the selected amount of the liquid ingredient.

### TECHNICAL FIELD

The subject application is related to different approaches to hair salon management, and more specifically, a networked data system that enables the generation of custom salon treatment mixtures for salon services.

### BACKGROUND

Demand for hair salon treatments has continued to increase as the variety and complexity of available services has increased as well. To keep up, stylists have needed to learn not only how to perform new services, but how to customize the services for different clients. With service providers having many clients, with many hair salon services available, and different customization approaches for the services, all of the information can become difficult to manage and utilize within hair salons.

### BRIEF DESCRIPTION OF THE DRAWINGS

The technology described herein is illustrated by way of example and not limited in the accompanying figures in which like reference numerals indicate similar elements and in which:

FIG. 1 is an architecture diagram of an example system that can facilitate using treatment recipes to generate tailored haircare mixtures for use by stylists for clients of a hair salon, in accordance with one or more embodiments.

FIG. 2 is a diagram of a non-limiting example system that can facilitate capturing treatment recipes by different stylists within and outside of a hair salon, in accordance with one or more embodiments.

FIG. 3 is a diagram of a non-limiting example system that can facilitate generating tailored haircare mixtures for use by stylists for clients of a hair salon, in accordance with one or more embodiments.

FIG. 4 depicts a sequence diagram that can facilitate using captured treatment recipes to generate tailored haircare mixtures for use by stylists for clients of a hair salon, in accordance with one or more embodiments.

FIG. 5 is a diagram of a non-limiting example system that can facilitate, based on crowdsourced cloud data, generating tailored haircare mixtures for use in a hair salon, in accordance with one or more embodiments.

FIG. 6 illustrates an example method that can facilitate capturing treatment recipes to generate tailored haircare mixtures for use in a hair salon, in accordance with one or more embodiments.

FIG. 7 depicts a system that can facilitate capturing treatment recipes to generate tailored haircare mixtures for use in a hair salon, in accordance with one or more embodiments.

FIG. 8 depicts an example non-transitory machine-readable medium that can include executable instructions that, when executed by a processor of a system, facilitate using captured treatment recipes to generate tailored haircare mixtures for use by stylists for clients of a hair salon, in accordance with one or more embodiments described above.

FIG. 9 illustrates an example block diagram of an example computer operable to engage in a system architecture that can facilitate processes described herein, in accordance with one or more embodiments.

### DETAILED DESCRIPTION

Generally speaking, one or more embodiments of a system described herein can facilitate using captured treatment recipes to generate tailored haircare mixtures for use by stylists for clients of a hair salon. In addition, one or more embodiments described herein can be directed towards a salon management system, with stylist and client data management capabilities, including tracking treatments applied to client's hair along with potential effects of treatment ingredients to both clients and stylists over time.

In some embodiments, non-limiting terms for hair treatment recipe ingredients are discussed to illustrate example uses for different equipment described herein, e.g., one having skill in the relevant art(s), given the description herein, appreciates how combining one or more of bleach, peroxide, hair coloring, and developer can be comprised in a hair treatment recipe (also termed recipe herein). It should be noted that additional or fewer types of ingredients can used with different recipes described herein without departing from the spirit of different embodiments. For instance, while many of the examples described herein are generally directed to hair coloring/bleaching treatments, any of the embodiments, aspects, concepts, structures, functionalities, or examples described herein are non-limiting, and the technology may be used in various ways with many different types of hair treatments and provide benefits to salon management generally.

In addition, one or more embodiments can comprise different specially designed devices that work together to handle ingredients in different states, including, but not limited to, powder and liquid form. Different forms of ingredients can be used without departing from the embodiments, including a solid, non-powdered form, a gaseous form, and other combinations of forms not yet developed for use in hair treatments.

In different embodiments, terms such as “signal propagation equipment” or simply “propagation equipment,” “radio network node” or simply “network node,” “radio network device,” “network device,” and access elements can be used to connect devices local to a salon (e.g., UEs operated by stylists, clients, and staff) to system components, and also for system components to connect to external data storage resources and information resource, e.g., ‘cloud’ based services. These terms may be used interchangeably and refer to any type of network node that can serve user equipment and/or be connected to other network node or network element or any radio node from where user equipment can receive a signal.

In some embodiments, the non-limiting term user equipment (UE) is used. This term can refer to any type of wireless device that can communicate with a radio network node in a cellular or mobile communication system. Examples of UEs include, but are not limited to, a target device, device to device (D2D) user equipment, machine type user equipment, user equipment capable of machine to machine (MTM) communication, PDAs, tablets, mobile terminals, smart phones, laptop embedded equipped (LEE), laptop mounted equipment (LME), USB dongles, and other equipment that can have similar connectivity. As discussed below, UEs can be used by one or more embodiments in some circumstances, by clients and stylists, to enter data into the system (e.g., by typing on a mobile screen, by reading data optically from a quick response (QR) code or bar code, and by wirelessly receiving data from radio frequency identifiers (RFIDs).

The computer processing systems, computer-implemented methods, apparatus and/or computer program products described herein employ selected combinations hardware and/or software to solve problems that are highly technical in nature (e.g., using client/stylist data to select treatment recipes and procedures), that are not abstract and cannot be performed as a set of mental acts by a human. For example, a human, or even a plurality of humans, cannot efficiently analyze and combine data from one or more salons to facilitate achieving a particular result for a particular client (which generally cannot be performed manually by a human or group of humans), with the same level of accuracy and/or efficiency as the various embodiments described herein.

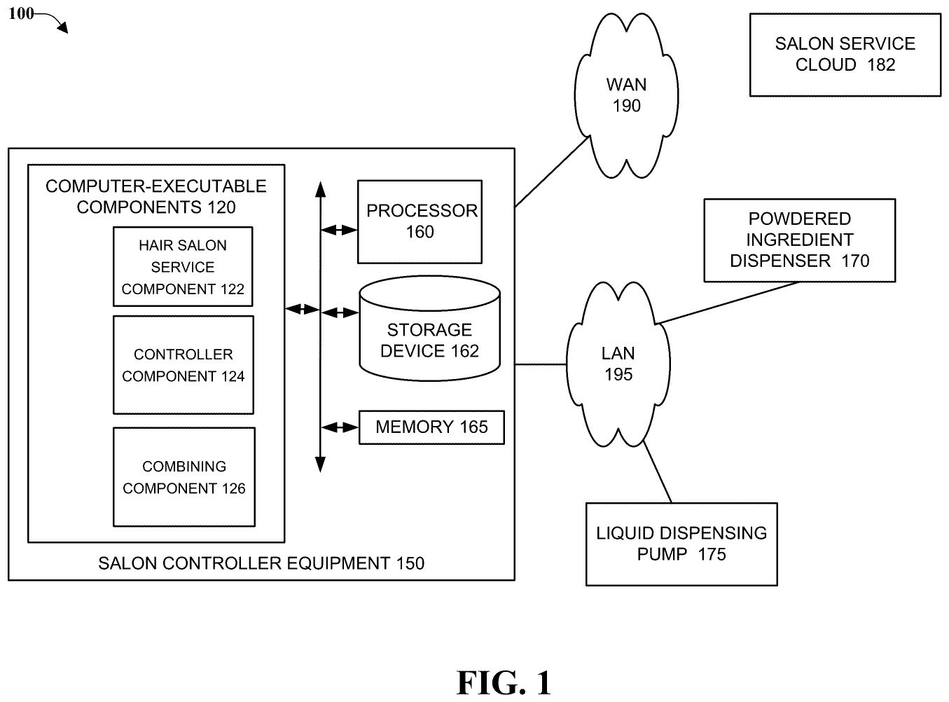

Aspects of the subject disclosure will now be described more fully hereinafter with reference to the accompanying drawings in which example components, graphs and selected operations are shown. In the following description, for purposes of explanation, numerous specific details are set forth in order to provide a thorough understanding of the various embodiments. For example, some embodiments described can facilitate capturing and using custom treatment recipes to generate tailored haircare mixtures for use by stylists for clients of a hair salon. Different examples that describe these aspects are included with the description of FIGS. 1-11 below. It should be noted that the subject disclosure may be embodied in many different forms and should not be construed as limited to this example or other examples set forth herein.

FIG. 1 is an architecture diagram of an example system 100 that can facilitate using captured treatment recipes to generate tailored haircare mixtures for use by stylists for clients of a hair salon, in accordance with one or more embodiments. For purposes of brevity, description of like elements and/or processes employed in other embodiments is omitted. System 100 can include salon controller equipment 150 communicatively coupled via local area network (LAN) 195 to powdered ingredient dispenser 170 and liquid dispensing pump 175, and via wide area network (WAN) 190 to salon service cloud 182.

As used herein, the term “pump” can broadly mean any apparatus that dispenses salon products (e.g., powder, cream, gel, spray, wax, pomade, gel, volumizer, shampoo, conditioner, etc.). Examples of networked product pumps are described herein, but these descriptions are non-limiting. In addition to pumps, some embodiments herein can use various apparatuses that can automatically dispense salon products by weight, e.g., a scale.

Salon controller equipment 150 can include processor 160, storage device 162, memory 165, and computer executable components 120. Computer executable components 120 can include different components that can enable the operation of one or more embodiments, including, but not limited to hair salon service component 122, controller component 124, cloud service component 126, and other components described or suggested by different embodiments described herein, that can improve the operation of system 100.

Further to the above, it should be appreciated that these components, as well as aspects of the embodiments of the subject disclosure depicted in this figure and various figures disclosed herein, are for illustration only, and as such, the architecture of such embodiments are not limited to the systems, devices, and/or components depicted therein. For example, in some embodiments, salon controller equipment 150 can further comprise various computer and/or computing-based elements described herein with reference to operating environment 1100 of FIG. 11.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 11. Such examples of memory 165 can be employed to implement any embodiments of the subject disclosure.

According to multiple embodiments, storage device 162 can include, but is not limited to, RAM, ROM, EEPROM, flash memory or other memory technology, solid state drive (SSD) or other solid-state storage technology, Compact Disk Read Only Memory (CD ROM), digital video disk (DVD), blu-ray disk, or other optical disk storage, magnetic cassettes, magnetic tape, magnetic disk storage or other magnetic storage devices, or any other medium which can be used to store the desired information and which can be accessed by the computer.

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a system on a chip (SOC), an array processor, a vector processor, and other types of processors. Further examples of processor 160 are described below with reference to processing unit 1104 of FIG. 11. Such examples of processor 160 can be employed to implement any embodiments of the subject disclosure.

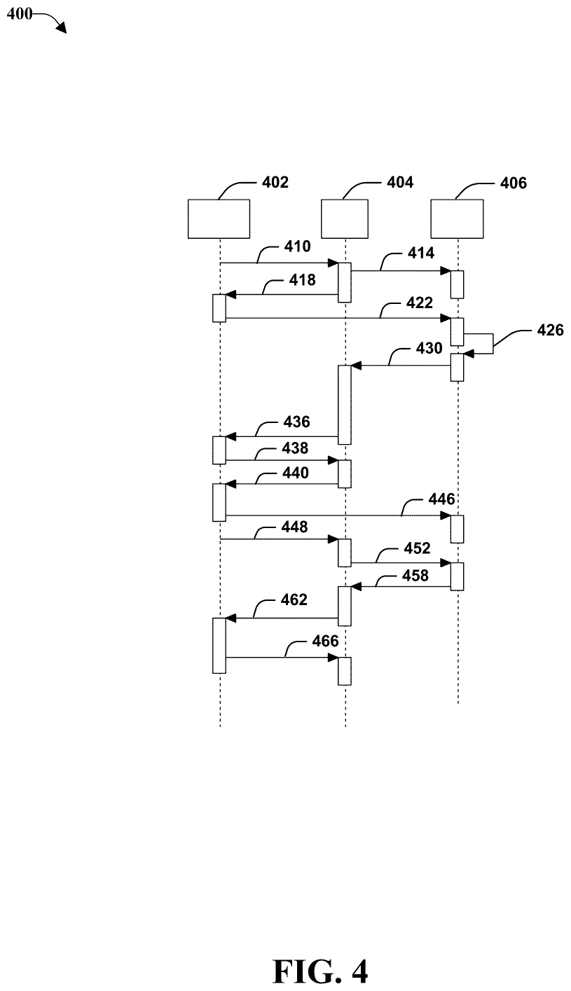

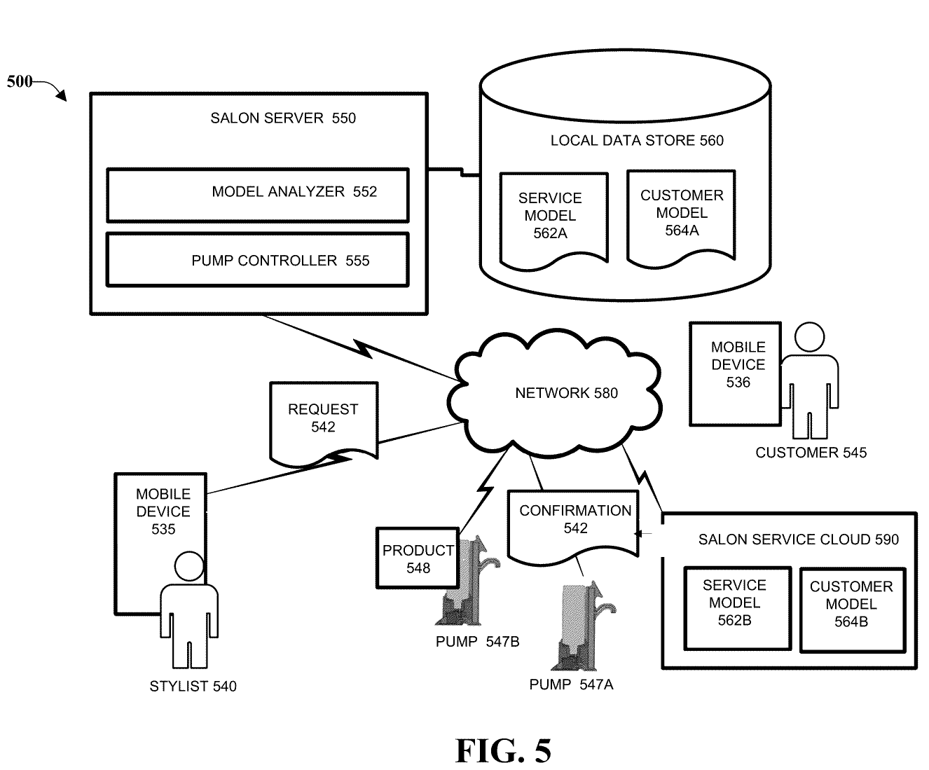

In one or more embodiments, computer executable components 120 can be used in connection with implementing one or more of the systems, devices, components, and/or computer-implemented operations shown and described in connection with FIG. 1 or other figures disclosed herein. For example, in one or more embodiments, computer executable components 120 can include instructions that, when executed by processor 160, can facilitate performance of operations defining hair salon service component 122. As discussed with FIGS. 4-5 below, hair salon service component 122 can, in accordance with one or more embodiments, based on a hair salon service to be performed, identify a first amount of a first ingredient and a second amount of a second ingredient, resulting in a combination of ingredients for the hair salon service

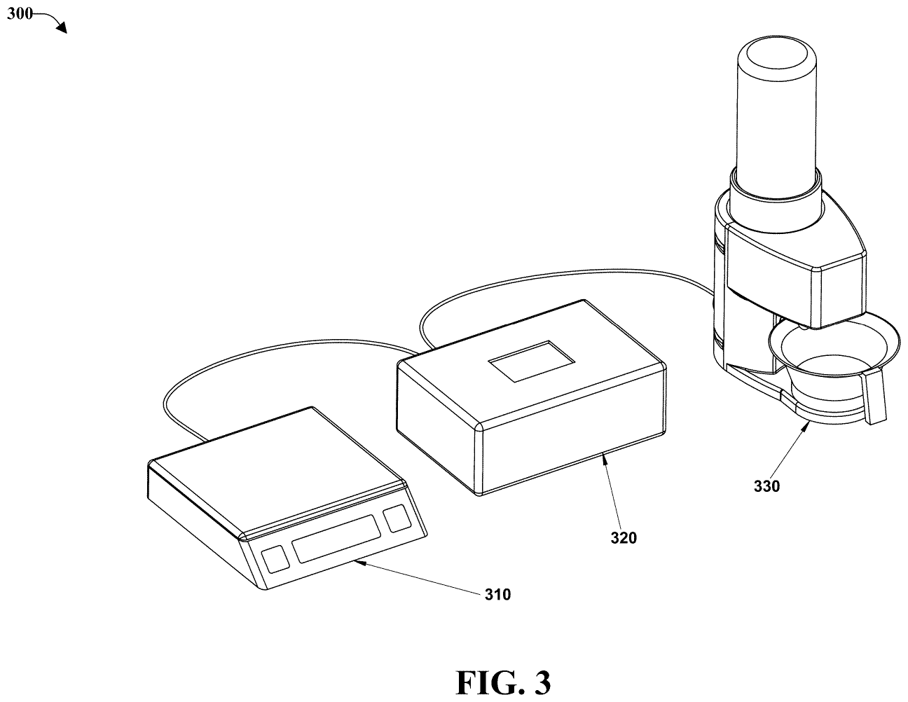

Further, in another example, in one or more embodiments, computer executable components 120 can include instructions that, when executed by processor 160, can facilitate performance of operations defining controller component 124. As discussed with FIGS. 3-4 below, controller component 124 can, in accordance with one or more embodiments, based on the selected amount of the powdered ingredient, dispense, by the automatic liquid dispensing pump, a selected amount of a liquid ingredient. For example, in one or more embodiments, based on the selected amount of the powdered ingredient, dispense, by the automatic liquid dispensing pump, a selected amount of a liquid ingredient.

In yet another example, computer executable components 120 can include instructions that, when executed by processor 160, can facilitate performance of operations defining cloud service component 126. As discussed herein, cloud service component 126 can, facilitating, by the salon equipment, combine the selected amount of the powdered ingredient and the selected amount of the liquid ingredient. For example, in one or more embodiments, facilitating, by the salon equipment, combine the selected amount of the powdered ingredient and the selected amount of the liquid ingredient. As discussed further with FIG. 3 below, different variables in treatment application include mixture ingredients selected, ratio of ingredients in a mixture, present condition of a client's hair, previous treatments, experience of the stylist, and the time treatment is applied to hair. Different factors that can be measured as results of a salon treatment include, desired condition of hair after treatment (resulting color of hair), unintended condition of hair following treatment, subjective evaluation by client or other stylists.

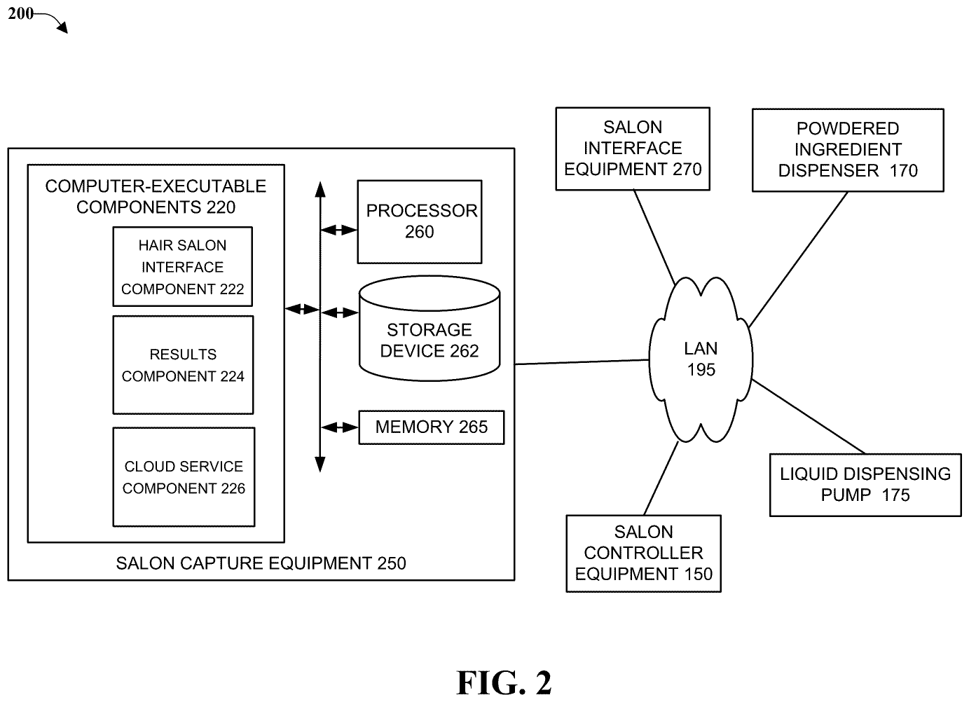

FIG. 2 is a diagram of a non-limiting example system 200 that can facilitate capturing treatment recipes by different stylists within and outside of a hair salon, in accordance with one or more embodiments. For purposes of brevity, description of like elements and/or processes employed in other embodiments is omitted. As depicted, system 200 can include salon capture equipment 250 communicatively coupled via LAN 195 to salon interface equipment 270, powdered ingredient dispenser 170, liquid dispensing pump 175, and salon controller equipment 150.

Salon capture equipment 250 can include processor 260, storage device 262, memory 265, and computer executable components 220. Computer executable components 220 can include different components that can enable the operation of one or more embodiments. In one or more embodiments, memory 265 is similar to memory 165 and can store one or more computer and/or machine readable, writable, and/or executable components and/or instructions 220 that, when respectively executed by processor 260, can facilitate performance of operations defined by the executable component(s) and/or instruction(s).

In system 200, computer executable components 220 can include but are not limited to hair salon interface component 222, results component 224, cloud service component 226, and other components described or suggested by different embodiments described herein, that can improve the operation of system 200. For example, in one or more embodiments, computer executable components 220 can be used in connection with implementing one or more of the systems, devices, components, and/or computer-implemented operations shown and described in connection with FIG. 2 or other figures disclosed herein.

For example, in one or more embodiments, computer executable components 220 can include instructions that, when executed by processor 260, can facilitate performance of operations defining hair salon interface component 222. As discussed with FIGS. 4-5 below, in one or more embodiments, hair salon interface component 222 can receive first user input regarding a hair salon service to be performed.

In another example, in one or more embodiments, computer executable components 220 can include instructions that, when executed by processor 260, can facilitate performance of operations defining, results component 224. As discussed with FIGS. 4-5 below, results component 224 can, in accordance with one or more embodiments, identify service information comprising an amount of the combination of ingredients used for the hair salon service and result information corresponding to a result of the hair salon service. In an example implementation, the result information can include a period of time that the combination of ingredients was in contact with hair to facilitate performance of the hair salon service.

In another example, in one or more embodiments, computer executable components 220 can include instructions that, when executed by processor 260, can facilitate performance of operations defining cloud service component 226. As discussed with FIGS. 4-5 below, cloud service component 226 can, in accordance with one or more embodiments, store in a cloud-based service recipe system, recipe information corresponding to the hair salon service, the first amount of the first ingredient, the second amount of the second ingredient, and the feedback.

FIG. 3 is a diagram of a non-limiting example system 300 that can facilitate a multi-phase hair salon knowledge sharing system that can aggregate stylist knowledge to generate custom haircare treatment mixtures, in accordance with one or more embodiments. For purposes of brevity, description of like elements and/or processes employed in other embodiments is omitted. As depicted, system 300 includes powdered ingredient scale 310, liquid dispensing pump 330, and salon controller equipment 320.

With respect to salon controller equipment 150 and salon capture equipment 250, it should be noted that one or more embodiments are designed to facilitate the collection and use of the knowledge of stylists, not only in a single salon, but in salons globally. In one implementation, an initial, data collection only phase can be used to gather information from the everyday use of stylists performing different services.

In some approaches to this collection phase, only treatment mixture data is collected and stored, e.g., a hair coloring product selected by the stylist (e.g., identified for the system based on a bar code or RFID), and an amount of the product that the stylist requests be dispensed from the system, e.g., dispensed by powdered ingredient scale 310 or an amount entered manually into the system. The stylist could then allow the system to calculate and dispense an amount of developer based on the product, amount, and type of developer available, or the stylist could request an amount of developer based on their experience. Summarizing this phase, one or more embodiments can provide convenient ways to dispense ingredients (along with guidance if requested), and capture certain parameter values (type, amount) selected by the stylists. In one or more embodiments, the convenience and services provided by the system can be used to encourage use (and therefore knowledge capture) by stylists.

One having skill in the relevant art(s), given the disclosure herein, would understand that different, more expansive implementations of the collection phase can collect other parameters for salon treatment selected by stylists. For example, because results from many hair treatments are based on the time a mixture is applied, this can be captured, e.g., manually, by a timer device, or a smartphone application. Similarly, the mode of application of the mixture (e.g., with or without foil) can be captured, e.g., by an interface with pictures and convenient descriptive interface elements. These different variables collected can broadly be considered as elements of a salon treatment selected by the stylist, and one or more embodiments can be configured to capture these elements for existing treatments, as well as yet discovered elements of future treatments.

In a useful variation of this data, along with the different elements selected by the stylist, information about the stylist can be collected along with the treatment data. This information can be collected from a stylist or can be obtained by employment records, public records, and from surveys of other stylists in a practice area. Information collected can include amount of experience generally, education, as well as experience with different treatments, types of hair, and other variables. In addition, along with experience level of a stylist, the preferences of the stylist can also be recorded. One or more embodiments can include the information about the stylist and the preferences of the stylist in the data analyzed to select different combinations of hair products, recipes, and/or any other result of analysis by the system described herein.

For example, when storing data about a hair treatment approach by a stylist, the experience of the stylist can be considered when determining how to utilize the data for future treatments, e.g., data collected from a very experienced stylist can be weighted higher in usefulness than data collected from a less experienced stylist.

Another set of parameters that can affect the results of a hair salon treatment is the condition of the hair upon which the treatment is applied. One or more embodiments can broadly be considered to capture different characteristics of hair that are both currently available and to be developed in the future. For some types of data, this information can be captured by a subjective characterization of the hair by the stylist, while for other types of data, measuring instruments can be interfaced with system elements, e.g., the pH of the hair at treatment time, as well as moisture levels, etc. In addition, images of the hair can be analyzed to determine hair condition. It should be noted that this hair condition information can also be collected over time, based on relationship data about a customer stored within a hair salon management system, and as described herein (e.g., with FIG. 5 below).

Customer data that can be retrieved for use as treatment parameters include previous treatments applied, e.g., previous colorings can affect subsequent treatments based on different characteristics. Other customer data can be subjective evaluations of the results of the treatment by a customer, e.g., satisfaction level with color and satisfaction with the amount of time required for the treatment.

Another type of data that can be collected and correlated with stylist selected salon treatment parameters is data associated with the results of the salon treatment. As noted above, subjective measures of satisfaction from the treated client can be used to measure results, and the results discussed in this section are associated with objective measurements of results, including, but not limited to, a resulting hair color and the condition of treated hair, e.g., characteristics of hair that can be measured such as pH and moisture levels. As would be appreciated by one having skill in the relevant art(s), given the description herein, hair color can be assessed after treatment using image analysis techniques. In an example use of results information, duration information for the treatment can be collected and correlated to parameters and other results. In one or more embodiments, by using this system of correlated treatment parameters, results, and treatment duration, clients can select services based on results that include the amount of time that needs to be dedicated to a particular treatment.

As with the discussion of other embodiments herein, the above examples from the collection phase of different stylist-selected parameters, other variables that affect results. In the second phase, the collected data can be analyzed and combined with other data. For example, stylist selected amounts of ingredients and application times can be combined with suggested values from manufacturer data stored, e.g., resources from a manufacturer that describe suggested application parameters for use. Additional results that can be determined based on analysis of the data described above are discussed below with other embodiment phases.

In an example implementation, different approaches to combining data can be used by embodiments to provide the ingredients discharged by the automated dispensers discussed herein. In an example, this collection of analyzed data can be collected for a single salon or collected and shared to multiple salons for use, e.g., as a cloud-based service.

FIG. 4 depicts a sequence diagram 400 that can facilitate automated dispensing of haircare mixture ingredients for use by stylists for clients of a hair salon, in accordance with one or more embodiments. For purposes of brevity, description of like elements and/or processes employed in other embodiments is omitted. Diagram 400 depicts a sequence of communications between salon service provider (SSP) 402, controller 404, and scale 406.

In example sequence diagram 400, communications shown include: SSP login to controller 410, controller initialize scale 414, controller prompt put cup on scale 418, SSP position cup on scale 422, scale zeroize to cup weight 426, scale measure weight and send cup weight 430, controller sends prompt for product barcode 436, SSP scans product barcode 438, controller notice of product dispensing 440, dispense product into cup 446, scan another product 448, request weight 452, send weight 458, update formula display 462, select completion 466.

FIG. 5 is a diagram of a non-limiting example system 500 that can facilitate, based on crowdsourced cloud data, generating tailored haircare mixtures for use in a hair salon, in accordance with one or more embodiments. For purposes of brevity, description of like elements and/or processes employed in other embodiments is omitted.

In one or more embodiments, 500 for coordinated distribution of products 548 (e.g., hairstyling products) using automatic pumps 548A-B connected over a computer network 580. Distribution of products 548 is based on request 542 for customer 545. System 500 further includes salon server 550 having model analyzer 552 and pump controller 555, and coupled to local data store 560.

In some embodiments, customer 545 is a customer requesting services from a hair salon. In some embodiments, customer 545 is modeled by a complex data structure (e.g., customer model 564) that models their interactions with components including product 548 and stylist 540. As noted above with the discussion of FIG. 3, having instances of customer model 564A-B available can provide embodiments with a rich source of data upon which customization of hair treatment recipes can occur. One having skill in the relevant art(s), given the description herein appreciates additional benefits that can accrue from use of instances of customer model 564A-B, including but not limited to, for both stylist and client, protecting from product interactions and excessive product exposure. In some embodiments, using complex customer model 564A-B, along with network product dispensation (e.g., using pumps 547A-B) results in improvements, using processes that are performed by a computer, to a variety of hair salon processes, some of which are discussed herein.

In an example embodiment, customer 545 requests a service from stylist 540 (e.g., a color application). Stylist 540 interacts with salon server 550 (e.g., by generating a request 542). In some embodiments, request 542 is generated by mobile device 535 after stylist 540 simply enters the service requested (e.g., color hair a color shade). It is worth noting that, in this example, no specific products are specified, only the service requested. Upon receiving this service request, salon server 550 determines which products are required, and uses pump controller 555 to request dispensation of one or more products from pumps 547A-B. In another example, request 542 is a request for specific products, not just the services. As discussed below, some embodiments can analyze requests for specific products and automatically provide dispensation of substitute products to achieve a result (e.g., protecting from unhealthy exposure to chemicals, maintaining stock levels of certain products, etc.). Other benefits can include for example, retrieving a color combination that was previously used by customer 545, as stored in customer model 564A-B.

In some embodiments, salon server 550 can determine an amount of product to use based on different factors. As discussed above with FIGS. 1-3, salon treatment mixtures can require two or more products 548, and the respective amounts can be selected by stylist 540 (e.g., during the collection phase described above) or by elements of system 500 (e.g., during data sharing phase).

One having skill in the relevant art(s), given the description herein, appreciates how, during the example data sharing phase described with FIG. 3 above, some embodiments can select combination of colored products 548 based on calculations of color mixtures to achieve certain colors. One way a color could be selected by embodiments could be using a camera (in mobile devices 535, 536, a kiosk in the salon), such camera being directed at a chosen color (e.g., in a magazine, or a live picture of colored hair), and the color being compared to captured result colors described with FIG. 3 above.

Once salon server 550 receives a chosen color, amounts of one or more color products 548 can be selected, and pump controller 555 can direct pumps 547A-B to dispense products 548 for use by stylist 540. As discussed further below, additional factors can influence the products and amounts of products selected by salon server 550.

As discussed above, some embodiments enable the networked control of product dispensation apparatus (e.g., pumps 547A-B) to dispense automatically determined products and amounts for selected hair salon services. In some embodiments, the amount each product dispensed by pumps 547A-B can be confirmed by confirmation 542 message being relayed to salon server 550. Some embodiments also track how each product was handled by stylist 540 (e.g., with or without gloves, breathing of products with or without a respirator), and applied to customer 545 (e.g., to hair, skin, nails, etc.). At salon server 550, confirmation 542 can be used to update models stored in local data store 560 to change the models based on their exposure to products 548.

In some embodiments, each product dispensed for, and used on customer 545 is described by specific values (e.g., amount, product, way used/applied), and these values are used to update customer model 564. For example, certain studies have determined that some hair products (e.g., products containing phthalates, formaldehyde, etc.) may be broadly dangerous to certain groups, while other chemical ingredients only cause problems for specific individuals. This information and similar information suggested by the disclosure herein can be integrated as described with FIG. 3 above to provide guided combinations of ingredients for hair treatment recipes.

Some embodiments of salon server 550 retrieve product information from external computer data servers (e.g., salon service cloud 590) and use this information to assess potentially harmful effects of products 548 dispensed. In some embodiments, salon server 550 can be configured to prevent the use of certain harmful products, while in other embodiments, the use of certain products can be monitored for bother stylists 540 and customers 545.

In an example: When customer 545 has a product (A) dispensed by pump 548 for use in a salon service, the amount of this product (e.g., 3 oz) is relayed to salon server 550, along with how the product was applied, e.g., on hair and scalp. Salon server, having retrieved information about product (A) from product data 595 stored in salon service cloud 590, determines that the 3 ounces applies results in 300 milligrams of a chemical (X) being applied to the hair and scalp of customer 545. Because the health impact of chemical (X) has been retrieved from product health data 591, certain recommended exposure values for chemical (X) can be determined (e.g., for both stylist 540 and customer 545). Customer model 564 can be updated to register the change in customer 545 due to exposure (e.g., the customer now being estimated to only be able to safely be exposed to 600 more milligrams of chemical (X) in the next year). This exposure information can be broadly used by embodiments for different automatic functions, e.g., preventing the use of a product where exposure is over a particular level, automatic selection of alternative products based on the selection of a service (if the same service is selected by customer 545, a product without chemical (X) can automatically be selected for dispensation).

Continuing this example, service model 562 may also be updated based on the use of product (A) and chemical (X). In some embodiments, stylist 540 works with and is exposed to product 548 after product 548 is distributed from a pump 547A. Stylists 540, in a way similar to that described for customer 545 above, may also have exposure levels tracked by some embodiments, but stylists can have automatic reminders generated by some embodiments to remind about the use of protective gear (e.g., gloves, masks, etc.) for certain products. In some embodiments, when a product is applied by a stylist, the protective gear used during application by stylist 540 can also be relayed to salon server 550 (e.g., by an application running in mobile device 535), and these protections can be used to set threshold exposure levels (e.g., chemical (X) is estimated to be able to be safely used at a level of 600 mg/year without skin contact protection, but a level of 6000 mg/year is safe with skin contact protection). In some embodiments, the automatic selection of other products to be used can also be applied to the use by stylist 540 over a period of time (e.g., select an alternative product when more than a certain amount of chemical (X) is used in a particular day, week, etc.).

As noted above, an RFID associated with stylist 540 can be used to link stylist 540 with a dispending pump 547. In some embodiments, this used of RFID and other similar technologies can also be used to establish what protective gear was used for a particular dispenses product, e.g., gloves, masks, respirators, etc., may have RFIDs that are read by pump 547 thus enabling the automatic collection of this information for use by embodiments. One having skill in the relevant art(s), given the description herein, will appreciate how this automatic detection of the use of protective gear can help promote healthy use of the products by both stylist 540, and customer 545. In some embodiments, salon server 550 can be configured to prevent the dispensation of products or combinations of products if protective gear is not detected. Similarly, to have product dispensed, salon server 550 may gather the intended use of the product (e.g., on skin), and confirm (e.g., using models from local data store 560) this the intended use of the product (by a specific stylist 540, in a particular way, on a specific customer 545) is valid.

In some embodiments, the interaction of products 548 is monitored. For example, when product data 595 (or any other source) indicates that products A and B, when combined in a particular way (the way the products are used once dispensed being included, for example, with confirmation 542) could be harmful and/or ineffective, embodiments can be configured to be able to warn, prevent, and/or automatically select alternative products/amounts of products that perform similar functions.

In some embodiments, products 548 can be dispensed that may not broadly cause problems to customers 545, but may cause problems for individual customers. Mobile device 536, running an application by customer 545, can be used to gather preferences/heath requirements from customer 545 and update customer model 564 to reflect these characteristics of customer 545. In some embodiments, as a benefit to stylist 540, this ability to set preferences can be used by mobile device 535 to update service model 562 to reflect the characteristics of stylist 540.

In some embodiments, the monitoring and automatic selection of products (and substitutes for products) can be applied to the optimization of product 548 inventory in a salon. Salon server 550, can have data that describes current inventory level of different products (both in pumps 547, which have sensors that show remaining product), and in stock reserves. To help optimize the purchase and use of products 548, inventory levels can be used as a value to control the selection of products and the amounts of products. For example, substitute products can automatically be selected based on a low in inventory value, products can be mixed to preserve the volume of one product by replacing with another, substantially equivalent product. In some embodiments, salon server 550 can select the pricing of different procedures based on the inventories of products and the predicted use based on past use of the products.

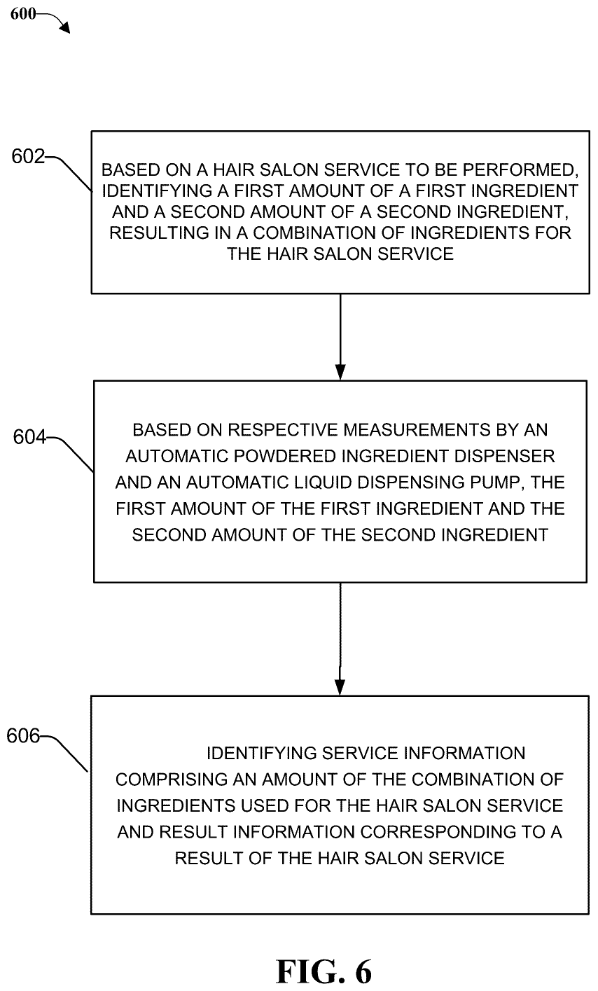

FIG. 6 illustrates an example method 600 that can facilitate capturing treatment recipes to generate tailored haircare mixtures for use in a hair salon, in accordance with one or more embodiments. For purposes of brevity, description of like elements and/or processes employed in other embodiments is omitted.

At 602, method 600 can include based on a hair salon service to be performed, identifying a first amount of a first ingredient and a second amount of a second ingredient, resulting in a combination of ingredients for the hair salon service. At 604, method 600 can include, based on respective measurements by an automatic powdered ingredient dispenser and an automatic liquid dispensing pump, the first amount of the first ingredient and the second amount of the second ingredient. At 606, method 600 can include identifying service information comprising an amount of the combination of ingredients used for the hair salon service and result information corresponding to a result of the hair salon service.

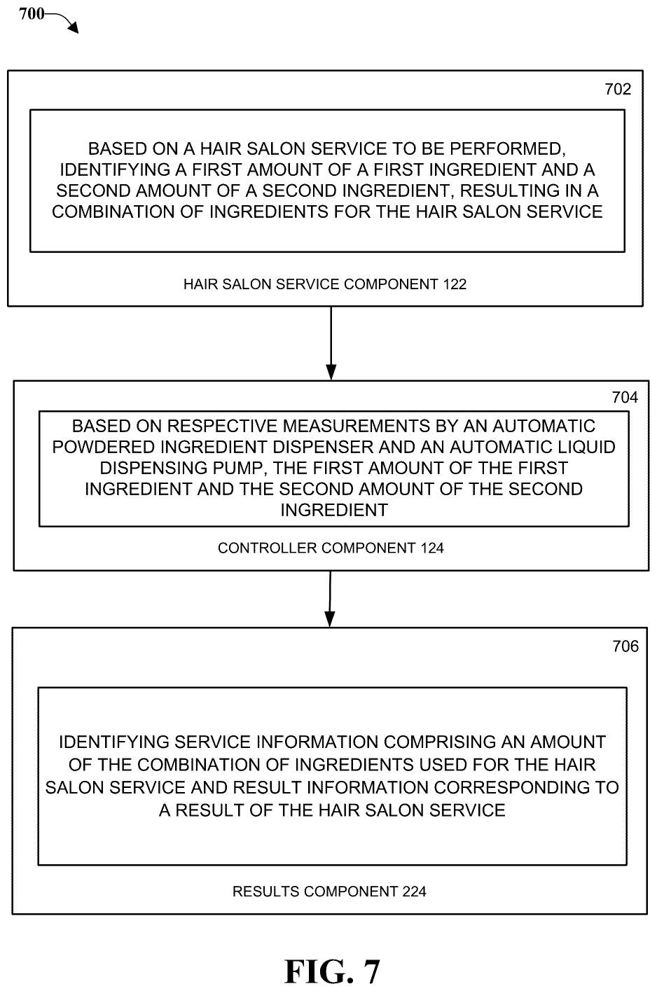

FIG. 7 depicts a system 700 that can facilitate capturing treatment recipes to generate tailored haircare mixtures for use in a hair salon, in accordance with one or more embodiments. For purposes of brevity, description of like elements and/or processes employed in other embodiments is omitted. As depicted, system 700 can include hair salon service component 122, controller component 124, cloud service component 126, and other components described or suggested by different embodiments described herein, that can improve the operation of system 700.

In an example, component 702 can include the functions of hair salon service component 122, supported by the other layers of system 700. For example, component 702 can, based on an identified service request to perform a service for a client and a measurement by the automatic powdered ingredient dispenser, dispense, by salon equipment comprising a processor, a selected amount of a powdered ingredient. In this and other examples, component 704 can include the functions of controller component 124, supported by the other layers of system 700. Continuing this example, in one or more embodiments, component 704 can, based on respective measurements by an automatic powdered ingredient dispenser and an automatic liquid dispensing pump, the first amount of the first ingredient and the second amount of the second ingredient.

In an example, component 706 can include the functions of results component 224, supported by the other layers of system 700. For example, component 706 can identify service information comprising an amount of the combination of ingredients used for the hair salon service and result information corresponding to a result of the hair salon service.

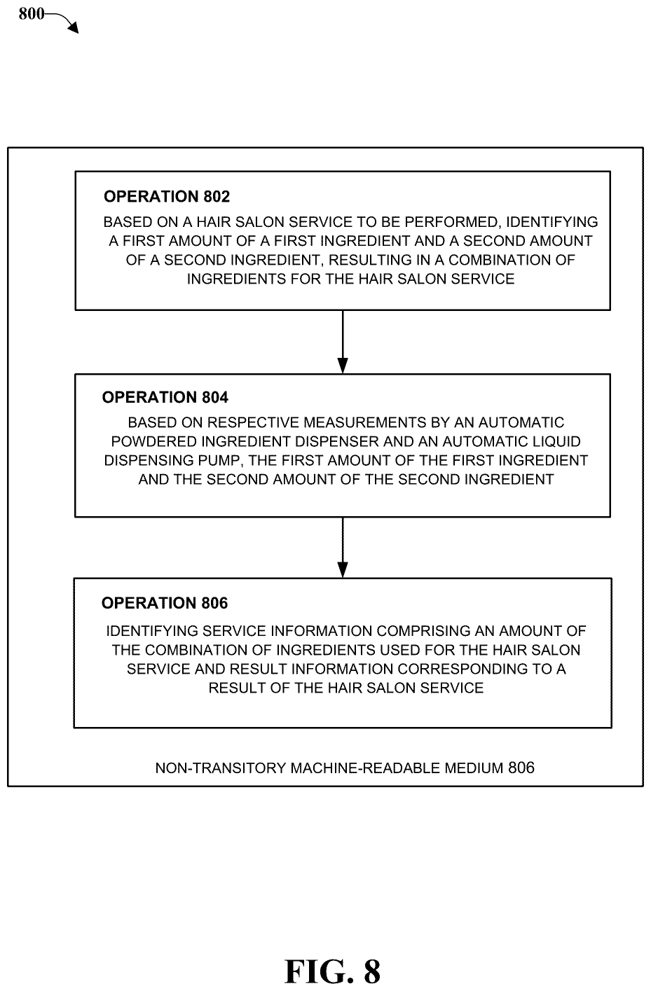

FIG. 8 depicts an example 800 non-transitory machine-readable medium 810 that can include executable instructions that, when executed by a processor of a system, facilitate using captured treatment recipes to generate tailored haircare mixtures for use by stylists for clients of a hair salon, in accordance with one or more embodiments described above. For purposes of brevity, description of like elements and/or processes employed in other embodiments is omitted. As depicted, non-transitory machine-readable medium 810 includes executable instructions that can facilitate performance of operations 802-806.

In one or more embodiments, the operations can include operation 802 that can, based on a hair salon service to be performed, identify a first amount of a first ingredient and a second amount of a second ingredient, resulting in a combination of ingredients for the hair salon service. Operations can further include operation 804, that can, based on respective measurements by an automatic powdered ingredient dispenser and an automatic liquid dispensing pump, the first amount of the first ingredient and the second amount of the second ingredient. In one or more embodiments, the operations can further include operation 806 that can identify service information comprising an amount of the combination of ingredients used for the hair salon service and result information corresponding to a result of the hair salon service.

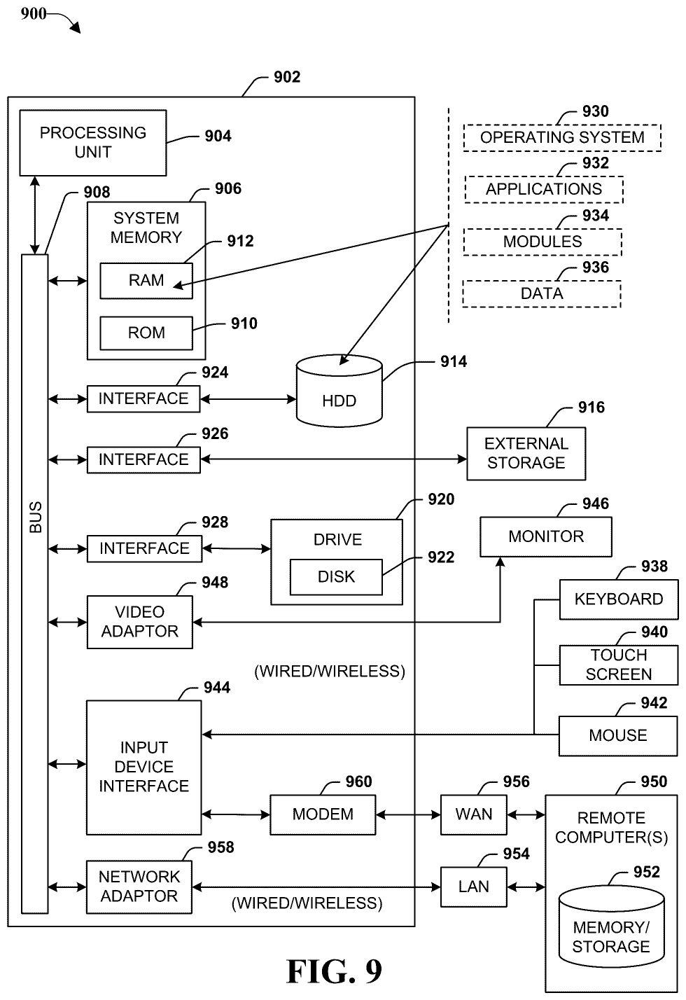

FIG. 9 provides additional context for various embodiments described herein, intended to provide a brief, general description of a suitable operating environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example operating environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and a drive 920, e.g., such as a solid-state drive, an optical disk drive, which can read or write from a disk 922, such as a CD-ROM disc, a DVD, a BD, etc. Alternatively, where a solid-state drive is involved, disk 922 would not be included, unless separate. While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and drive 920 can be connected to the system bus 908 by an HDD interface 924, an external storage interface 926 and a drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enable with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above, such as but not limited to a network virtual machine providing one or more aspects of storage or processing of information. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further to the description above, as it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine-readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Additionally, the terms “core-network,” “core,” “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment do not normally connect directly to the core networks of a large service provider, but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim.

While the various embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope of the various embodiments.

In addition to the various implementations described herein, it is to be understood that other similar implementations can be used, or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be affected across a plurality of devices. Accordingly, the embodiments are not to be limited to any single implementation, but rather are to be construed in breadth, spirit, and scope in accordance with the appended claims.

What is claimed is:

1. A method, comprising:
receiving, by salon equipment comprising a processor, first user input regarding a hair salon service to be performed;
based on the hair salon service to be performed, identifying, by the salon equipment, a first amount of a first ingredient and a second amount of a second ingredient, resulting in a combination of ingredients for the hair salon service, and an application time for the combination of ingredients;
based on a first measurement by an automatic powdered ingredient dispenser, dispensing, by the salon equipment, the first amount of the first ingredient;
based on a second measurement by an automatic liquid dispensing pump, dispensing, by the salon equipment, the second amount of the second ingredient;
identifying, by the salon equipment, service information comprising:
an actual amount of the combination of ingredients used for the hair salon service
an actual application time that the combination of ingredients was applied, and
result information corresponding to a result of the hair salon service; and
storing, by the salon equipment, in a service recipe system, recipe information corresponding to the hair salon service, the first amount of the first ingredient, the second amount of the second ingredient, the actual application time, and the result information.

2. The method of claim 1, wherein the hair salon service comprises a hair coloring service, wherein the first ingredient comprises a powdered hair color ingredient, and wherein the second ingredient comprises a liquid color developer solution.

3. The method of claim 1, further comprising, based on a first hair condition before performance of the hair salon service, updating the recipe information.

4. The method of claim 3, wherein the result information comprises a comparison of the first hair condition to a second hair condition after performance of the hair salon service.

5. The method of claim 4, further comprising, based on a difference between an expected hair condition associated with the actual amount of the combination of ingredients and the second hair condition, updating the recipe information.

6. The method of claim 4, further comprising, based on feedback regarding the second hair condition, updating the recipe information, wherein the feedback is received from sources comprising, a hair stylist and a client to whom the hair salon service was applied.

7. The method of claim 6, wherein the recipe information is updated further based on client information of the client, relevant to use of the combination of ingredients and the hair salon service.

8. The method of claim 1, wherein the hair salon service comprises a first hair salon service and the combination of ingredients comprises a first combination, and wherein the method further comprises:
based on a second hair salon service to be performed, retrieving, by the salon equipment, the recipe information from a salon service data system;
based on the recipe information, identifying, by the salon equipment, a third amount of the first ingredient and a fourth amount of the second ingredient, resulting in a second combination of ingredients for the second hair salon service;
based on a third measurement by the automatic powdered ingredient dispenser, dispensing, by the salon equipment, the first amount of the first ingredient;
based on a fourth measurement by the automatic liquid dispensing pump, dispensing, by the salon equipment, the second amount of the second ingredient; and
based on the recipe information, generating a service order for application of the second combination of ingredients.

9. A salon device, comprising:
a processor; and
a memory that stores executable instructions that, when executed by the processor, facilitate performance of operations, comprising:
receiving first user input regarding a hair salon service to be performed,
based on the hair salon service to be performed, identifying a first amount of a first ingredient and a second amount of a second ingredient, resulting in a combination of ingredients for the hair salon service,
based on a first measurement by an automatic powdered ingredient dispenser, dispensing the first amount of the first ingredient,
based on a second measurement by an automatic liquid dispensing pump, dispensing the second amount of the second ingredient,
identifying service information comprising an amount of the combination of ingredients used for the hair salon service and result information corresponding to a result of the hair salon service, and
storing in a service recipe system, recipe information corresponding to the hair salon service, the first amount of the first ingredient, the second amount of the second ingredient, and feedback associated with the result of the hair salon service.

10. The salon device of claim 9, wherein the hair salon service comprises a hair coloring service, wherein the first ingredient comprises a hair color ingredient, and wherein the second ingredient comprises a color developer solution.

11. The salon device of claim 9, wherein the result information comprises a period of time that the combination of ingredients were in contact with hair to facilitate performance of the hair salon service.

12. The salon device of claim 9, wherein the result information comprises client information relevant to use of the combination of ingredients and the hair salon service.

13. The salon device of claim 9, wherein the result information comprises a comparison of the first hair condition to a second hair condition after the performance of the hair salon service.

14. The salon device of claim 13, further comprising, based on a difference between an expected hair condition associated with the amount of the combination of ingredients and the second hair condition, updating the recipe information.

15. The salon device of claim 9, wherein the feedback was received from sources comprising at least one of, a hair stylist and a client to whom the hair salon service was applied.

16. A non-transitory machine-readable medium, comprising executable instructions that, when executed by a processor of salon equipment, facilitate performance of operations, comprising:
receiving first user input regarding a hair salon service to be performed;
based on the hair salon service to be performed, identifying a first amount of a powdered ingredient and a second amount of a liquid ingredient, resulting in a combination of ingredients for the hair salon service;
based on a first measurement by an automatic powdered ingredient dispenser, dispensing the first amount of the powdered ingredient;
based on a second measurement by an automatic liquid dispensing pump, dispensing the second amount of the liquid ingredient;
identifying service information comprising an amount of the combination of ingredients used for the hair salon service and result information corresponding to a result of the hair salon service; and
storing in a service recipe system, recipe information corresponding to the hair salon service, the first amount of the powdered ingredient, the second amount of the liquid ingredient, and feedback received from sources comprising at least one of, a hair stylist and a client to whom the hair salon service was applied.

17. The non-transitory machine-readable medium of claim 16, wherein the hair salon service comprises a hair coloring service, wherein the powdered ingredient comprises a hair color ingredient, and wherein the liquid ingredient comprises a color developer solution.

18. The non-transitory machine-readable medium of claim 16, wherein the result information comprises client information relevant to use of the combination of ingredients and the hair salon service.

19. The non-transitory machine-readable medium of claim 16, wherein the result information comprises a comparison of the first hair condition to a second hair condition after the performance of the hair salon service.

20. The non-transitory machine-readable medium of claim 19, further comprising, based on a difference between an expected hair condition associated with the amount of the combination of ingredients and the second hair condition, updating the recipe information.
